(19) United States
(12) Patent Application Publication
(10) Pub. No.: US 2011/0180173 A1
(43) Pub. Date: Jul. 28, 2011

(54) Tapping Channel for Draining Iron and Metal Melts and Liquid Slags from Metallurgical Containers Such as Blast Furnaces and Melt Furnaces

(76) Inventors: Klaus Spies, Aachen-Schmitthof (DE); Philippe Malivoir, Errouville (FR); Claude Meisch, Roeser (LU); Luc Richartz, Diekirch (LU); Peter Cramer, Burbach (DE); Hans-Uwe Morhenstern, Freudenburg (DE); Jurgen Pithan, Siegen (DE); Ralf Taugerbeck, Netphen (DE)

(21) Appl. No.: 13/056,819

(22) PCT Filed: Aug. 6, 2009
(86) PCT No.: PCT/EP09/60228

§ 371 Date: Mar. 30, 2011

(30) Foreign Application Priority Data
Aug. 7, 2008 (DE) 10 2008 036 790.7

(51) Int. Cl. F16L 9/18

(52) U.S. Cl. 138/111

(57) ABSTRACT

The invention relates to a tapping channel (1) for draining iron and metal melts and liquid slags from metallurgical containers such as blast furnaces (2) and melt furnaces. The tapping channel (1) is formed by an outer pipe (3) and an inner pipe (4) disposed therein in an axially displaceable manner, wherein the outer pipe (3) is rigidly connected to the refractory lining (5) of the furnace (2) and wherein both pipes (3, 4) comprise a highly refractory material.

The invention pertains to tapping channels for draining iron and metal melts and liquid slag from metallurgical containers, particularly blast furnaces and melt furnaces.

In order to drain the pig iron melt and the liquid slag from blast furnaces, one or more taphole channels are arranged in the lower region of the furnace and extend through the refractory lining that in most cases has a thickness of several meters. In order to interrupt the melt flow being discharged from the furnace and to seal the tapholes after a tapping process, plastic plugging compound is pressed into the tapping channels over their entire length with special plugging machines until a so-called mushroom forms on the inner wall of the blast furnace. The internal pressure of the blast furnace or melt furnace must be overcome when the plugging compound is pressed into the taphole channel. The plugging compound hardens due to the high temperatures and thusly forms a sealing plug.

In order to open the taphole channel for another tapping process, a bore hole is produced through the hardened plugging compound until the melt in the interior of the blast furnace is reached such that the melt flow begins anew. In this case, the mushroom formed by the plugging compound on the refractory lining of the inner wall of the blast furnace has the function of protecting the inner wall of the blast furnace from the wear occurring on the inlet opening of the taphole channel due to the melt being discharged and, in particular, the slag. During the tapping process, the hardened plugging compound is subjected to chemical and abrasive wear over the entire length of the taphole channel such that the taphole channel undesirably widens in an uncontrollable fashion.

The taphole channel is opened for another tapping process from outside by means of drills or hammer drills that are guided on pivoted mounting arms, wherein the drills are equipped with drill rods of corresponding length. Once the drill bit of a drill rod reaches the molten bath in the furnace, the bit and the front parts of the drill rod are molten off.

DE 44 92 636 C2 discloses a method for producing a drain channel for a taphole on a shaft furnace, in which a refractory pipe is pushed onto a tapping rod and axially inserted into a plugging compound injected into the taphole. In this method, essentially only the front end of the pipe is inserted into the plugging compound such that a large portion of the pipe protrudes referred to the wall of the shaft furnace. The pipe is locked in the extension of the taphole and the taphole can be opened by pulling the tapping rod out of the hardened plugging compound through the pipe such that the drain channel of the taphole within the wall of the shaft furnace is formed directly in the plugging compound and the drain channel is extended by the pipe outside the wall of the shaft furnace.

According to FR 260 301 30, JP-A-58800 1007, JP-A-6300 7308 and SU-A-605 068, it is known to install a pipe of refractory material into the plugging compound, wherein said pipe leads into the molten bath in the interior of the shaft furnace and extends through the wall of the shaft furnace. This refractory pipe forms a drain channel in the plugging compound used for plugging the taphole and prevents the melt flow being discharged from the shaft furnace from directly contacting the plugging compound. The pipe inserted into the plugging compound is supposed to significantly increase the wear resistance of the wall of the taphole referred to the melt flow being discharged, but the insertion of the pipe into the plugging compound is extraordinarily complex and practically impossible in blast furnaces with linings that have a thickness of several meters in the region of the taphole.

The invention is based on the objective of developing a tapping channel for draining iron and metal melts and liquid slag from metallurgical containers, particularly blast furnaces and melt furnaces, which is highly resistant to the abrasive and chemical wear caused by the melt and slag flow being discharged from the furnace and can be replaced within regular time intervals in a much faster and less expensive fashion than conventional embodiments of taphole channels.

According to the invention, this objective is attained with a tapping channel with the characteristics of claim 1.

The dependent claims define advantageous and practical additional developments of the tapping channel.

The inventive tapping channel for blast furnaces and melt furnaces provides the following advantages:

Due to the realization in the form of a double pipe with an outer pipe of highly refractory material that is rigidly connected to the lining of a blast furnace or melt furnace and an inner pipe that can be axially displaced therein and consists of pipe sections of a highly refractory material that is also resistant to abrasive and chemical wear, the tapping channel is characterized by a high fatigue strength. Furthermore, the pipe sections of the inner pipe can be replaced within regular time intervals in a much faster and less expensive fashion than conventional tapping channels.

The inventive tapping channel is described below with reference to schematic drawings, in which:

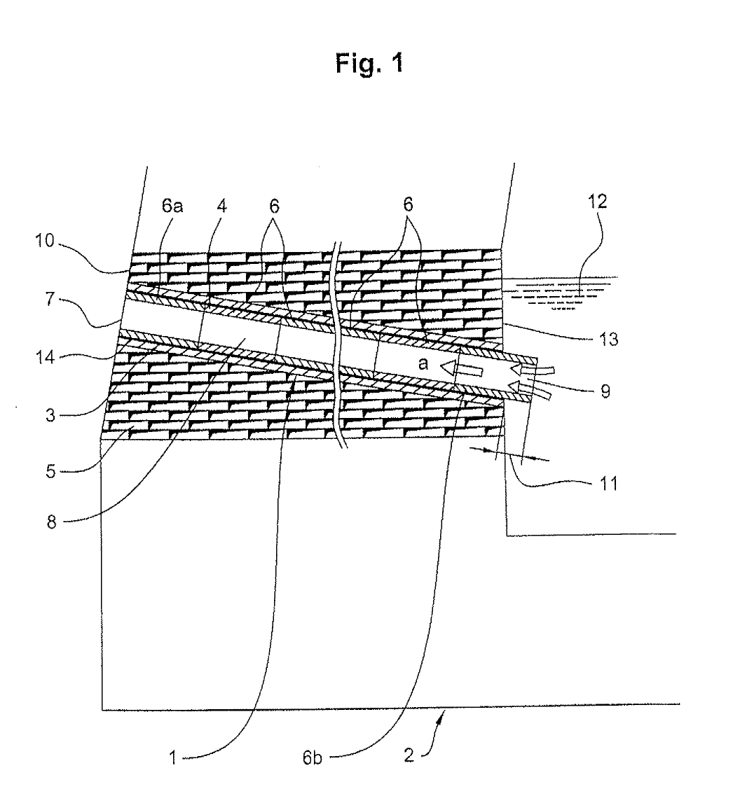

FIG. 1 shows a longitudinal section through the tapping channel,

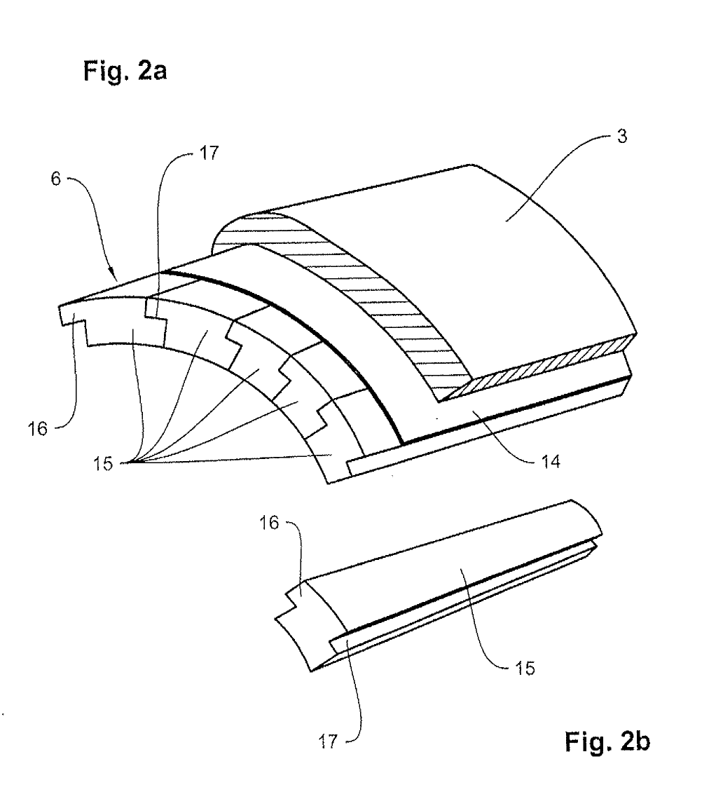

FIGS. 2a and 2b show an enlarged perspective representation of an inner pipe section of the tapping channel that is composed of pipe segments, as well as an enlarged perspective representation of a pipe segment,

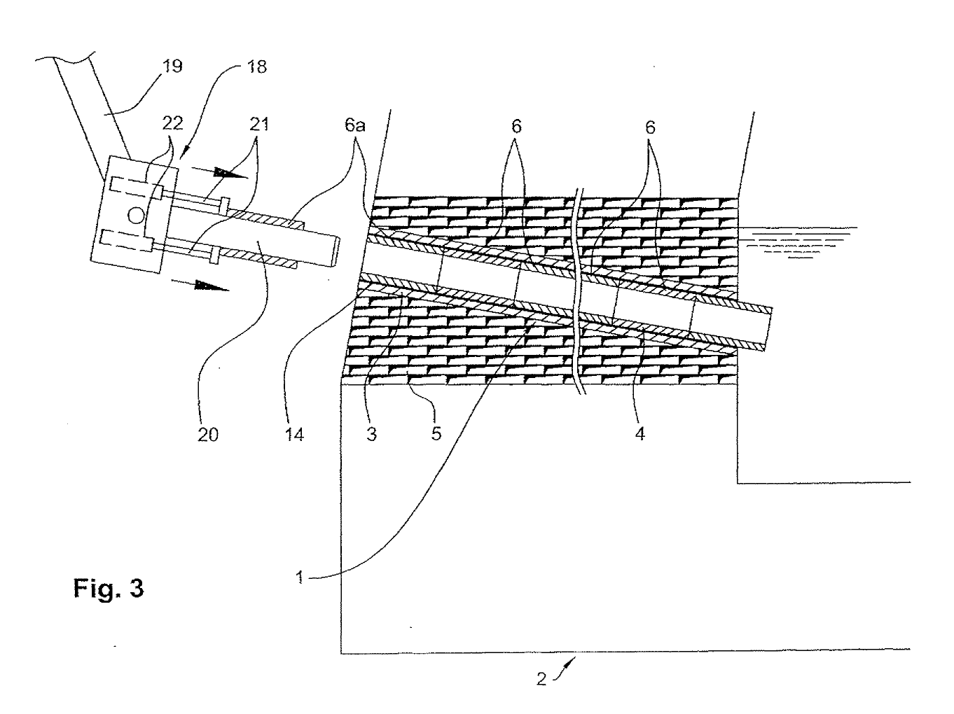

FIG. 3 shows a longitudinal section through a machine for inserting the inner pipe sections prior to the insertion of an inner pipe section into the outer pipe of the tapping channel of a blast furnace,

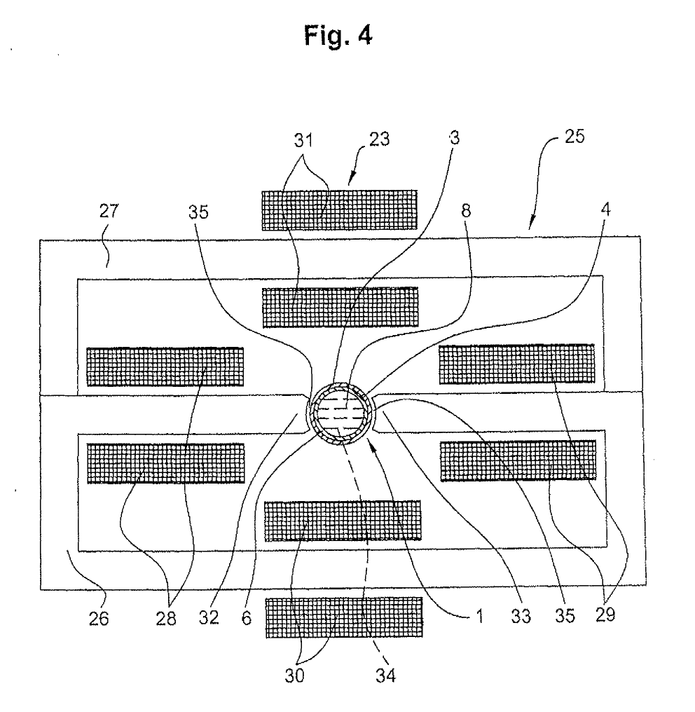

FIG. 4 shows a cross section through the tapping channel that is equipped with a device for controlling the flow velocity and for decelerating the melt flow,

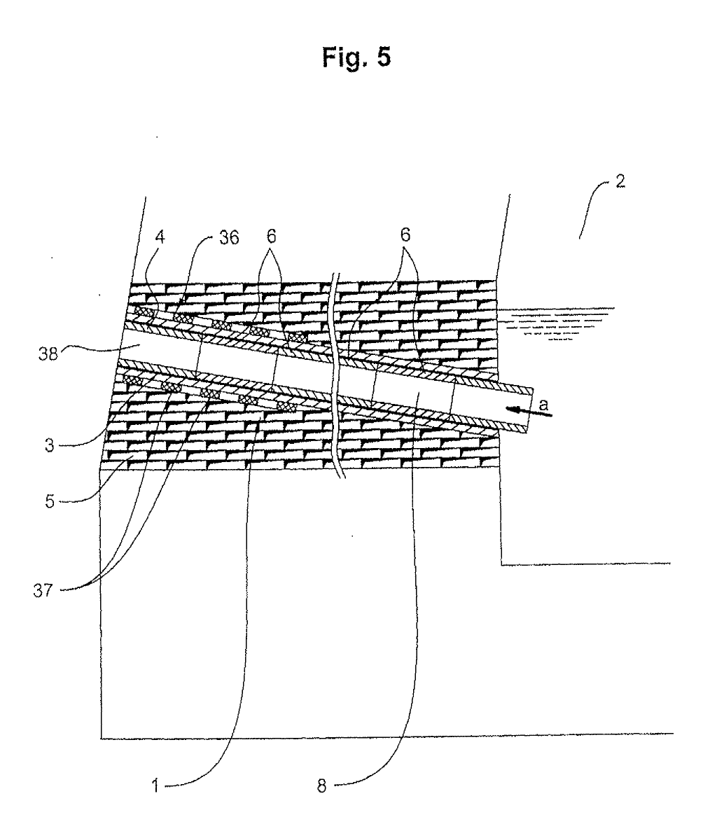

FIG. 5 shows a longitudinal section through a tapping channel that is equipped with a cooling device, and

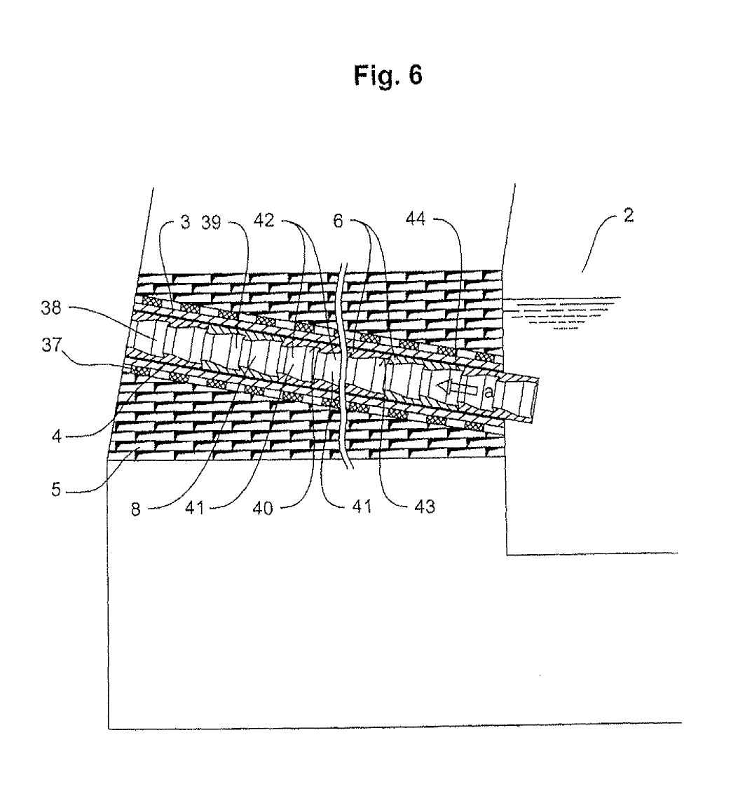

FIG. 6 shows a longitudinal section through another embodiment of the tapping channel with an outer pipe and an inner pipe with a profiled inner wall.

The tapping channel 1 of a blast furnace 2 illustrated in FIG. 1 is composed of an outer pipe 3 and an inner pipe 4 that can be axially displaced therein, wherein the outer pipe 3 is rigidly connected to the refractory lining 5 of the blast furnace 2 by means of mortar. Both pipes 3, 4 consist of a highly refractory, preferably ceramic material or carbonaceous stone and the material of the inner pipe 4 that serves for impeding the abrasive and chemical wear caused by the pig iron and the slag being discharged also is resistant to abrasive and chemical wear.

The inner pipe 4 consists of pipe sections 6 that are replaced with new pipe sections 6a within certain time intervals in order to compensate the occurring abrasive and chemical wear, wherein the new pipe sections 6a are pushed into the outer tube 3 opposite to the flow direction a of the melt flow 8 being discharged from the blast furnace 2 through the outlet opening 7 of the tapping channel 1 and worn out pipe sections 6b are simultaneously pushed out of the outer tube 3 and into the blast furnace 2 through the inlet opening 9 of the tapping channel 1. At its outlet opening 7, the tapping channel 1 ends approximately flush with the outer wall 10 of the blast furnace. The inner pipe section 6b, through which the melt flow 8 is introduced into the tapping channel 1 of the blast furnace 2, protrudes into the melt 12 by a certain distance 11 in order to protect the outer pipe 3 and the lining 5 of the blast furnace 2 from abrasive wear such that no abrasive wear can occur on the outer pipe 3 of the tapping channel 1 and on the inner wall 13 of the blast furnace due to drainage whirlpools when the pig iron, the pig iron/slag mixture and the highly abrasive slag drains from the blast furnace 2 during the tapping process.

This inner pipe section 6b fulfills the function of the so-called mushroom that is formed by the plugging compound on the inner side of the lining of the blast furnace in conventional tapping methods. The time interval between the insertions of new pipe sections 6a is chosen such that the destruction of the inner pipe section 6 is prevented and any contact of the melt and the slag with the outer pipe 3 is precluded.

A layer 14 of a lubricant, preferably a mineral-based lubricant, is situated between the outer pipe 3 and the inner pipe sections 6, wherein this lubricant fully develops its sliding properties at the high temperatures of the iron and slag flow being discharged and only solidifies at temperatures that lie significantly below those of liquid metal.

The inner pipe 4 absorbs the wear that occurs during the tapping process at the inlet of the tapping channel and over the entire length of the tapping channel and is caused by the pig iron, the pig iron/slag mixture and, in particular, the aggressive slag. The outer pipe 3 is protected from any wear such that the tapping channel 1 maintains its shape and is not widened.

The inner pipe sections 6 are much more resistant to wear than the conventional plugging compound that solidifies during the tapping process. With respect to the material selection, the only requirement to be fulfilled by these pipe sections is that they have the highest resistance to wear possible while the plugging compound is also subject to other requirements such as, for example, plasticity during the plugging process and drillability in order to begin the next tapping process.

However, even the highly wear-resistant inner pipe sections 6 are subjected to wear over time despite their significantly lower rate of wear. In this respect, the arrangement of the outer pipe 3, the lubricant 14 and the inner pipe sections 6 ensures that worn out inner pipe sections 6 can be pushed into the blast furnace 2 and replaced with new inner pipe sections before they are destroyed. The material of the inner pipe section is chosen such that they disintegrate after an extended period of time in the melt in the interior of the blast furnace due to the flowage and whirlpools occurring therein and their residues are removed through the tapping channel during subsequent tapping processes.

Different methods can be used for interrupting the tapping process such as, for example, conventional plugging, wherein the plugging compound only needs to have wear properties in this case, but no longer needs to be wear-resistant. In the new tapping channel with a double pipe, it is advantageous to use powder cartridges for sealing the tapping channel. It is furthermore possible to utilize slides and shutters, as well as a purposeful solidification of the melt in the tapping channel, in order to stop the tapping process, wherein the solidified melt is in the latter instance subsequently re-melted in order to initiate another tapping process.

In another embodiment of the tapping channel 1 that is illustrated in FIGS. 2a and 2b, the inner pipe sections 6 consist of rod-shaped pipe segments 15 that are arranged axially adjacent to one another. In order to prevent the inner pipe sections 6 consisting of the pipe segments 15 from collapsing during the insertion into the outer pipe 3 of the tapping channel 1 and during the tapping process, the pipe segments 15 are connected to one another in a form-fitting fashion. For this purpose, the outer circumference of the rod-shaped pipe segments 15 respectively features a longitudinal web 16 on one side and a shoulder 17 that is adapted to the longitudinal web 16 on the opposite side, namely such that the longitudinal web 16 of one pipe segment 15 engages with the shoulder 17 of the adjacent pipe segment 15 during the assembly of the pipe sections 6 of the inner pipe 4.

The advantage of realizing the inner pipe sections in the form of a number of rod-shaped pipe segments that are arranged axially adjacent to one another and connected in a form-fitting fashion can be seen in that the worn out inner pipe sections, which are pushed out of the outer pipe and into the blast furnace or melt furnace on the inlet side of the tapping channel when new inner pipe sections are inserted into the outer pipe on the outlet side of the tapping channel, collapse into the rod-shaped pipe segments that are subsequently removed from the blast furnace through the tapping channel together with the melt being discharged during subsequent tapping processes. Since the pipe segments have lost a significant portion of their original thickness when they are pushed into the interior of the blast surface due to the abrasive wear that has occurred during the tapping processes carried out over an extended period of time, they break into pieces on the inlet side of the tapping channel on the inner wall of the blast furnace due to the flow energy and the formation of whirlpools when the iron and the slag flow into the tapping channel.

During the insertion of new inner pipe segments into the outer pipe of the tapping channel, the pipe segments are held together with corresponding auxiliary means.

FIG. 3 shows a machine 18 for inserting inner pipe sections 6a into the outer pipe 3 of the tapping channel 1 of the blast furnace 2. The machine is arranged on a rotatable and pivotable boom 19 and able to insert new inner pipe sections 6a into the outer pipe 3 of the tapping channel 1, as well as to push these inner pipe sections into the tapping channel. For this purpose, the tapping channel 1 is initially sealed with a plug 20 that simultaneously serves as a guide for the new pipe section 6a to be inserted and pushed into the tapping channel. After the tapping channel 1 is sealed, the piston rods 21 of the lifting cylinders 22 of the machine 18 push the new pipe section 6a into the outer pipe 3. This process is preferably carried out once the tapping process is completed and the tapping channel 1 needs to be sealed. After the new pipe section 6a has been pushed into the outer pipe, the tapping channel 1 can be sealed with conventional plugging compound or by utilizing a powder cartridge or other methods for sealing the tapping channel.

FIG. 4 shows a tapping channel 1 that is equipped with a device 23 for controlling the flow velocity and for decelerating and stopping a non-ferromagnetic melt flow 8. The control device 23 features a core 25 that is realized in the form of a double yoke with two yokes 26, 27, on which four electric induction coils 28-31 are arranged. The core 25 has two poles 32, 33 that are arranged around the tapping channel 1. The induction coils 28-31 generate a magnetic field 24 that acts upon the melt flow 8 in the tapping channel 1 via the narrow gaps 35 between the poles 32, 33 and the outer pipe 3, the outer pipe and the inner pipe sections 6, namely in such a way that eddy currents are generated in the melt flow 8, wherein forces that are directed opposite to the flow direction a of the melt flow 8 and decelerate this melt flow are generated due to the interaction between the magnetic field and the eddy currents. In this case, magnetic fields with the same polarity or alternating magnetic fields can be used.

With respect to the process technology, the control device provides the advantage that the melt flow only needs to be interrupted when new inner pipe sections 6a need to be inserted and pushed into the outer pipe 3 of the tapping channel 1.

The tapping channel 1 according to FIG. 5 is equipped with a cooling device 36 in the form of tubular cooling spirals 37 that surround the tapping channel 1 over the entire length of the tapping channel 1 or—as in this exemplary embodiment—over a section thereof and are arranged as close as possible to the outer pipe 3. Melt flows 8 that are significantly decelerated by the magnetic fields of the control device 23 according to FIG. 4 can be solidified after a tapping process on a blast furnace with the cooling effect of the cooling medium flowing through the cooling spirals 37 such that a sufficiently strong sealing plug 38 is formed in the outlet region of the tapping channel 1. Eddy currents generated with the electric induction coil system according to FIG. 4 or electric induction coils extending around the tapping channel make it possible to re-melt the sealing plug 38 of solidified melt on its outer circumferential surface that is in contact with the inner pipe sections 6 such that the plug is pressed out of the tapping channel under the influence of the internal pressure of the blast furnace and a new tapping process can be initiated.

However, the cooling process can also be controlled so sensitively that a solidification or an extremely viscous state of the melt flow shortly before the solidification point is only realized in the outer region of the melt flow that directly adjoins the inner pipe sections and an inner coating is produced on the inner wall of the inner pipe sections. In this way, the inner pipe sections are protected from the entire wear or at least the predominant portion thereof.

The tapping channel 39 according to FIG. 6 is composed of an outer pipe 3 and an inner pipe 4 that consists of pipe sections 6, the inner walls 40 of which are realized in the form of groins 41, namely such that an in-line arrangement of groins 41 is formed, the openings 42 of which are tapered in the flow direction a of the melt flow 8. Due to this in-line arrangement of groins 41, the flow velocity of the melt flow 8 on the inner walls 40 of the inner pipe sections 6 is significantly decelerated in comparison with the flow velocity of the central melt flow such that the abrasive wear of the inner pipe sections 6 is also reduced. The slow flow velocity of the melt flow 8 in the inner wall region of the pipe sections 6 of the inner pipe 4 of the tapping channel 39 makes it possible to significantly cool the melt in this region by means of the cooling medium that flows through the cooling spiral 37 surrounding the outer pipe 3 of the tapping channel 39 while the faster central melt flow is only cooled insignificantly or not at all. A solidified melt layer 44 that protects against wear is formed on the inner wall 43 of the inner pipe 4 that is composed of the inner walls 40 of the inner pipe sections 6. Due to the slower flow velocity of the melt flow 8 on the inner wall 43 of the inner pipe 4, a layer 44 of solidified or very viscous melt can be produced on the inner wall 43 of the inner pipe 4 of the tapping channel 39 under the influence of the cooling medium flowing through the cooling spirals 37 with a much lower expenditure of energy than in the tapping channel 1 according to FIG. 5. The groins 41 are also particularly advantageous in connection with the cooling spirals 37 if a tapping process should be stopped with a sealing plug 38 of solidified melt produced in the inner pipe 4 of the tapping channel 39.

1. A tapping channel for draining iron and metal melts and liquid slag from metallurgical containers, particularly blast furnaces and melt furnaces, said tapping channel comprising:
an outer pipe; and
an inner pipe axially displaced in said outer pipe, wherein the outer pipe is rigidly connected to a refractory lining of a furnace and both pipes consist of a highly refractory material.

2. The tapping channel according to claim 1, in which the inner pipe consists of pipe sections that are replaced with new pipe sections within certain time intervals in order to compensate for the abrasive and chemical wear caused by melt flow being discharged from the furnace, wherein the new pipe sections are pushed into the outer pipe opposite to the flow direction of the melt flow through the outlet opening of the tapping channel and worn out inner pipe sections are simultaneously pushed out of the outer pipe and into the furnace through the inlet opening of the tapping channel.

3. The tapping channel according to claim 2, in which the inner pipe section, through which the melt flow is introduced into the tapping channel of the furnace, protrudes into the furnace by a certain distance in order to protect the outer pipe and the inner wall of the furnace.

4. The tapping channel according to Claim 2, in which the inner pipe sections consist of rod-shaped pipe segments that are arranged axially adjacent to one another and connected in a form-fitting fashion.

5. The tapping channel according to claim 4, in which the outer circumference of the rod-shaped pipe segments respectively features a longitudinal web on one side and a shoulder that is adapted to the longitudinal web on the opposite side, namely such that the longitudinal web of one pipe segment engages with the shoulder of the adjacent pipe segment during the assembly of the pipe sections of the inner pipe.

6. The tapping channel according to claim 1, including a mineral-based lubricant that acts between the outer pipe and the inner pipe, wherein said lubricant fully develops its sliding properties at the high temperatures of the melt flow being discharged from the furnace and only solidifies at temperatures that lie significantly below those of the free-flowing melt and slag.

7. The tapping channel according to claim 1, in which the outer pipe and the inner pipe consist of a highly refractory ceramic material or carbonaceous stone and the material of the inner pipe is also resistant to abrasive and chemical wear.

8. The tapping channel according to one of claim 1, in which this tapping channel is equipped with a device for controlling the flow velocity and for decelerating and stopping non-ferromagnetic melt flows, wherein the control device features at least one core (25) of ferromagnetic material with at least two poles that are arranged around the tapping channel, and wherein electric induction coils are arranged on the core in order to generate at least one magnetic field that acts upon the melt flow in the tapping channel arranged between the two poles in such a way that a voltage is induced in the melt flow and this voltage generates eddy currents in the melt flow, wherein forces that influence the flow velocity of the melt flow are generated due to the interaction between the magnetic field and the eddy currents.

9. The tapping channel according to claim 1, in which this tapping channel is surrounded by a cooling device for transferring the melt flow into a solidified state after the tapping process and a heating device for melting the solidified melt in order to restore the melt flow for another tapping process.

10. The tapping channel according to one of claim 1, in which the inner walls of the inner pipe sections are in the form of groins with an opening that is tapered in the flow direction of the melt flow in order to decelerate the flow velocity in the outer region of the melt flow and to thusly reduce the abrasive and chemical wear on the inner walls of the inner pipe sections.

11. The tapping channel according to claim 10, in which a viscous or solidified melt layer that protects against wear is formed on the inner walls of the inner pipe sections by intensively cooling the melt flow that is decelerated in the outer region by means of a cooling spiral that surrounds the outer pipe.
